(19) United States
(12) Patent Application Publication
(10) Pub. No.: US 2021/0344159 A1
(43) Pub. Date: Nov. 4, 2021

(54) Single Crystal Fiber

(71) Applicant: Nippon Telegraph and Telephone Corporation, Tokyo (JP)

(72) Inventor: Shigeo Ishibashi, Musashino-shi, Tokyo (JP)

(21) Appl. No.: 17/285,429

(22) PCT Filed: Nov. 12, 2019
(86) PCT No.: PCT/JP2019/044335

§ 371 Date: Apr. 14, 2021

(30) Foreign Application Priority Data
Nov. 19, 2018 (JP) 2018-216531

(51) Int. Cl. H01S 3/067; H01S 3/16

(52) U.S. Cl. CPC H01S 3/06716; H01S 3/1643; H01S 3/1696

(57) ABSTRACT

Provided is a single-crystal fiber including a waveguide structure for a wavelength to be subjected to optical amplification, in which at least one end of the single-crystal fiber is planar, an angle θ between a normal to a facet of the single-crystal fiber and an optical axis of the single-crystal fiber satisfies a relationship of θ=90°−tan⁻¹(n₂/n₁), where n₁ represents a refractive index of a medium of a space that uses the single-crystal fiber, and n₂ represents a refractive index of the single-crystal fiber for a guided light beam having a polarization direction parallel with a plane that includes the normal to the facet and the optical axis, and a diameter Dx in an X-direction and a diameter Dy in a Y-direction of a cross-section of the single-crystal fiber perpendicular to the optical axis satisfies a relationship of (n₂/n₁)0.9≤Dx/Dy≤(n₂/n₁)1.1.

### TECHNICAL FIELD

The present invention relates to single-crystal fibers used for optically pumped solid-state lasers and optical amplifiers.

### BACKGROUND ART

As a femtosecond pulsed light source or a wide-band wavelength-variable light source, an optically pumped solid-state laser oscillator that uses a single-crystal fiber of Y₃Al₅O₁₂ doped with tetravalent Cr atoms (hereinafter referred to as Cr⁴⁺:YAG) has been developed. The single-crystal fiber is incorporated in a laser resonator including space optics, and thus forms a laser oscillator. Accordingly, a dispersion-compensating medium, a wavelength-selective element, a saturable absorber, and the like that are necessary for a desired laser oscillation operation can be incorporated as the parts of the space optics (for example, see Non-Patent Literatures 1 and 2).

FIG. 1 illustrates a laser resonator that uses a conventional single-crystal fiber. The laser resonator includes a single-crystal fiber 101 between its opposite ends, and also includes a concave spherical mirror 103 and a plane mirror 104 arranged to reflect output light beams from the opposite ends of the single-crystal fiber 101. The single-crystal fiber 101 is difficult to be produced as a single transverse mode waveguide. Thus, it is usually a multi-mode waveguide. An excitation light beam 106 from a pumping source is allowed to become incident on one end of the single-crystal fiber 101 via the plane mirror 104. An oscillated light beam 105 output from the other end of the single-crystal fiber 101 is reflected at an angle of 90° by the concave spherical mirror 103, whereby the laser resonator is allowed to have a function of selecting a waveguide mode and perform oscillation in the fundamental transverse mode. An output light beam of the laser oscillator is extracted via the concave spherical mirror 103.

FIG. 2 illustrates the structure of the conventional single-crystal fiber. The diameters Dx and Dy in two directions of a cross-section of the single-crystal fiber 101 that is perpendicular to its optical axis are roughly equal (FIG. 2(a)). Opposite facets 102a and 102b of the single-crystal fiber 101 have been polished perpendicularly (i.e., at 90°: Non-Patent Literature 1) or at an angle close thereto (i.e., at 85.5°: Non-Patent Literature 2) with respect to the longitudinal direction. Each of the opposite facets 102a and 102b is provided with an anti-reflective coating to prevent an increase in the round-trip loss of the resonator due to reflection for the wavelength (1.3 to 1.6 μm) of an oscillated light beam (FIG. 2(c)).

### CITATION LIST

### Non-Patent Literature

Non-Patent Literature 1: S. Ishibashi and K. Naganuma, “Diode-pumped Cr4+:YAG single crystal fiber laser,” OSA Advanced Solid-State Lasers, paper MD4, Davos, Switzerland, February 2000.
Non-Patent Literature 2: Shigeo Ishibashi and Kazunori Naganuma, “Mode-locked operation of Cr4+:YAG single-crystal fiber laser with external cavity,” Opt. Express 22, 6764-6771 (2014).
Non-Patent Literature 3: Kenji Kohno, “Basics and Applications of Optical Coupling Elements for Optical Devices,” pp. 34-40, 1991, Gendai Kogaku Sha.

### SUMMARY OF THE INVENTION

### Technical Problem

However, since the wavelength range of the excitation light beam (with a wavelength of 1.06 or 0.98 μm) and that of the oscillated light beam greatly differ, if the reflectivity for the oscillated light beam is minimized as a property of a dielectric multilayer film used as the anti-reflective coating, the facet reflectivity for the excitation light beam will increase. This results in decreased oscillation efficiency of the laser oscillator, which is problematic.

### Means for Solving the Problem

It is an object of the present invention to provide a single-crystal fiber that has low facet reflectivity for each of an oscillated light beam and an excitation light beam, and can obtain favorable optical coupling between an oscillated light beam propagating in a space of a resonator and the fundamental transverse mode by using only a concave spherical mirror for folding the oscillated light beam from one end of the fiber.

To achieve the foregoing object, an embodiment of the present invention provides a single-crystal fiber including a waveguide structure for a wavelength to be subjected to optical amplification, in which at least one end of the single-crystal fiber is planar, an angle θ between a normal to a facet of the single-crystal fiber and an optical axis of the single-crystal fiber satisfies a relationship of:
0=90°−tan⁻¹(n₂/n₁), where n₁ represents a refractive index of a medium of a space that uses the single-crystal fiber, and n₂ represents a refractive index of the single-crystal fiber for a guided light beam having a polarization direction parallel with a plane that includes the normal to the facet and the optical axis, and
a diameter Dx in an X-direction and a diameter Dy in a Y-direction of a cross-section of the single-crystal fiber perpendicular to the optical axis satisfies a relationship of:
(n₂/n₁)0.9Dx/Dy≤(n₂/n₁)1.1, where the X-direction is a direction perpendicular to the optical axis of the single-crystal fiber and the Y-direction is a direction perpendicular to the optical axis of the single-crystal fiber and to the X-direction in a plane that includes the optical axis of the single-crystal fiber and the normal to the facet of the single-crystal fiber.

### Effects of the Invention

According to the present invention, the facet reflectivity for each of an oscillated light beam and an excitation light beam is low, and favorable optical coupling can be obtained between an oscillated light beam propagating in a space of the laser resonator and the fundamental transverse mode of a light beam propagating in the single-crystal fiber. Thus, the oscillation efficiency of the laser oscillator can be improved.

### BRIEF DESCRIPTION OF DRAWINGS

FIG. 1 is a view illustrating a laser resonator that uses a conventional single-crystal fiber.

FIG. 2 illustrates the structure of the conventional single-crystal fiber in which FIG. 2(a) is a cross-sectional view, FIG. 2(b) is a top view, and FIG. 2(c) is an oblique projection view.

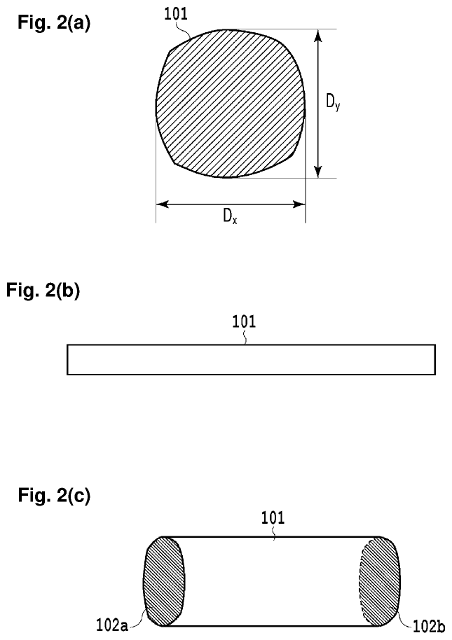

FIG. 3 is a view for illustrating the Brewster's angle in optical refraction.

FIG. 4 is a view illustrating a configuration in which each of an excitation light beam and an oscillated light beam is allowed to become incident on a facet of a single-crystal fiber at the Brewster's angle.

FIG. 5(a) is a view illustrating the shape of an oscillated light beam in a cross-section of a single-crystal fiber that has equal diameters in two directions orthogonal to each other within the cross-section, and FIG. 5(b) is a view illustrating the shape of the oscillated light beam immediately after it has emerged from the single-crystal fiber.

FIG. 6 illustrates propagation of an oscillated light beam that is reflected by a concave spherical mirror of a laser resonator with a configuration in which the oscillated light beam is allowed to become incident on or emerge from a facet of a single-crystal fiber, which has equal diameters in two directions orthogonal to each other within the cross-section, at the Brewster's angle in which FIG. 6(a) is a top view and FIG. 6(b) is a side view.

FIG. 7 illustrates the structure of a single-crystal fiber of the present embodiment in which FIG. 7(a) is a cross-sectional view and FIG. 7(b) is a top view.

FIG. 8(a) is a view illustrating the shape of an oscillated light beam in a cross-section of the single-crystal fiber of the present embodiment, and FIG. 8(b) is a view illustrating the shape of the oscillated light beam immediately after it has emerged from the single-crystal fiber.

FIG. 9 illustrates propagation of an oscillated light beam reflected by a concave spherical mirror of a laser resonator that uses the single-crystal fiber of the present embodiment in which FIG. 9(a) is a top view and FIG. 9(b) is a side view.

### DESCRIPTION OF EMBODIMENTS

Hereinafter, an embodiment of the present invention will be described in detail with reference to the drawings. The present embodiment exemplarily illustrates a single-crystal fiber that is used for an optically pumped solid-state laser or an optical amplifier, and has a waveguide structure for a wavelength to be subjected to optical amplification. As a material of the single-crystal fiber, Cr⁴⁺:YAG single crystals are used.

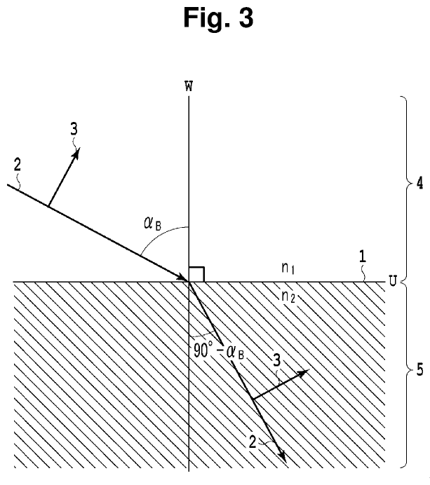

FIG. 3 is a view illustrating the Brewster's angle. When an incoming light beam 2 becomes incident on an interface 1 between a crystal 5 and a space 4, the Brewster's angle (α_{B}) is calculated by the following formula.

α_{B}=tan⁻¹(n₂/n₁) (Formula 1)

Herein, n₁ represents the refractive index of a medium of a space in the laser resonator, and the refractive index of the atmospheric air is n₁=1. n₂ represents the refractive index of a laser medium, and the refractive index of the YAG crystals is n₂=1.8. Thus, the Brewster's angle α_{B} is calculated as 61°.

In FIG. 3, an axis orthogonal to the U-axis and the W-axis (i.e., an axis perpendicular to the paper surface) is the V-axis. In the coordinate axes, it is assumed that the components parallel with the UW plane correspond to a P-polarized light beam (i.e., a polarization direction 3), and the components perpendicular to the UW plane correspond to an S-polarized light beam. Due to the incident angle dependence of the reflectivity for each of the P-polarized light beam and the S-polarized light beam, the reflectivity for the P-polarized light beam is zero at the Brewster's angle α_{B} and only the S-polarized light beam is reflected. A method for minimizing reflection at a facet without using an anti-reflective coating includes setting the angle between the optical axis of each of the excitation light beam and the oscillated light beam and the direction of the normal to the facet of the single-crystal fiber to the Brewster's angle α_{B}, and setting the polarization direction of each of the excitation light beam and the oscillated light beam to be parallel (i.e., P-polarization) with the plane (i.e., the UW plane) in which the optical axis of the incoming light beam and the optical axis within the single-crystal fiber exist.

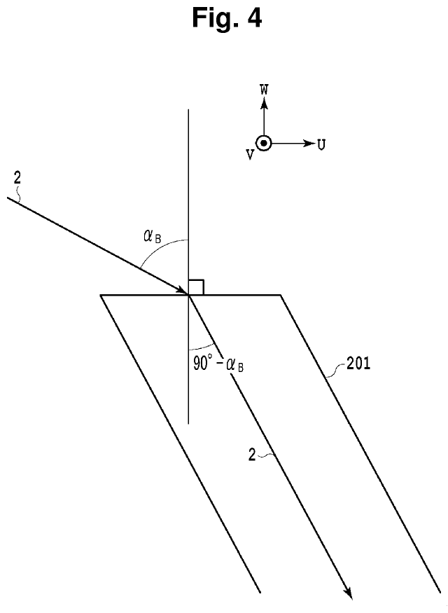

FIG. 4 illustrates a configuration in which each of an excitation light beam and an oscillated light beam is allowed to become incident on a facet of a single-crystal fiber at the Brewster's angle. Hereinafter, it is assumed for description purposes that the diameters of the single-crystal fiber 201 in two directions orthogonal to each other in its cross-section perpendicular to the optical axis are equal. However, the following description makes sense irrespective of the shape of the cross-section. To allow each of an excitation light beam and an oscillated light beam to become incident and emerge at the Brewster's angle α_{B}, it is necessary to set the angle between the direction of the normal to the facet of the single-crystal fiber 201 and the longitudinal direction of the fiber (i.e., the optical axis within the single-crystal fiber) to 90°−α_{B}, that is, 29°.

Provided that the direction of the normal to the facet of the single-crystal fiber 201 is set as the W-axis, and the U-axis is set so that the optical axis of the incoming light beam 2 and the optical axis of the single-crystal fiber 201 become parallel with the UW plane, the angle θ between the W-axis and the optical axis of the single-crystal fiber 201 is calculated as follows from Formula 1:

θ=90°−tan⁻¹(n₂/n₁) (Formula 2),
where n₂ is the refractive index of the medium in the single-crystal fiber 201 for the P-polarized light beam parallel with the UW plane.

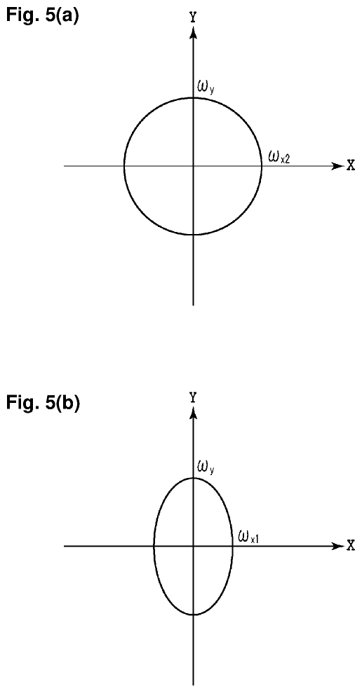

FIG. 5 illustrates the shape of a cross-section of an oscillated light beam. To illustrate the beam shape, the X-axis, the Y-axis, and the Z-axis are defined. The three axes form an orthogonal coordinate system. The Z-axis coincides with the optical axis, and the polarization direction of a P-polarized light beam at each point of the Z-coordinate coincides with the X-axis direction. Since the direction of the optical axis differs in the inside of the single-crystal fiber and in the outside space, the directions of the X-axis, the Y-axis, and the Z-axis change depending on the Z-coordinate.

FIG. 5(a) illustrates the shape of an oscillated light beam in a cross-section of the single-crystal fiber 201. It is assumed that in a plane including the optical axis of the single-crystal fiber 201 and the normal to the facet of the single-crystal fiber 201, the direction perpendicular to the optical axis of the single-crystal fiber 201 is the X-direction, and the direction perpendicular to the optical axis of the single-crystal fiber 201 and to the X-direction is the Y-direction. As described above, the diameters (Dx and Dy) in the two directions (i.e., the X-axis and the Y-axis) of the cross-section in a plane perpendicular to the optical axis of the single-crystal fiber 201 are equal.

FIG. 5(b) illustrates the shape of the oscillated light beam immediately after it has emerged at the Brewster's angle from the single-crystal fiber 201 that has equal diameters in the two directions of the cross-section in a plane perpendicular to the optical axis. The beam radius (ωₓ₁) with respect to the X-axis direction of the oscillated light beam propagating in the space of the resonator decreases to n₁/n₂ in comparison with the beam radius (ωₓ₂) within the single-crystal fiber.

ωₓ₁=(n₁/n₂)ωₓ₂ (Formula 3)

In contrast, the beam radius (ω_{y}) with respect to the y-axis direction does not change between the inside and outside of the single-crystal fiber.

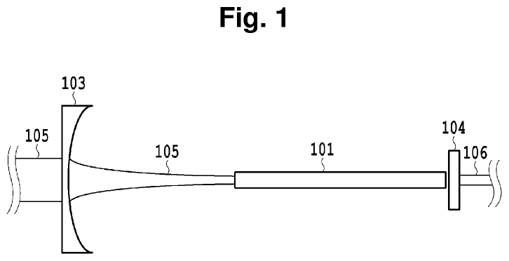

In the conventional laser resonator illustrated in FIG. 1, the oscillated light beam 105 that has emerged from a facet of the single-crystal fiber 101 is folded back by the concave spherical mirror 103 toward the single-crystal fiber 101, and is optically coupled to the facet again. Since Dx and Dy of the conventional single-crystal fiber 101 are equal, the radii in the two directions of the oscillated light beam that has emerged from the facet, which is perpendicular to the longitudinal direction, to the space are also equal. Thus, the oscillated light beam obtained by the concave spherical mirror 103 has beam waists generated at the same position for the two directions.

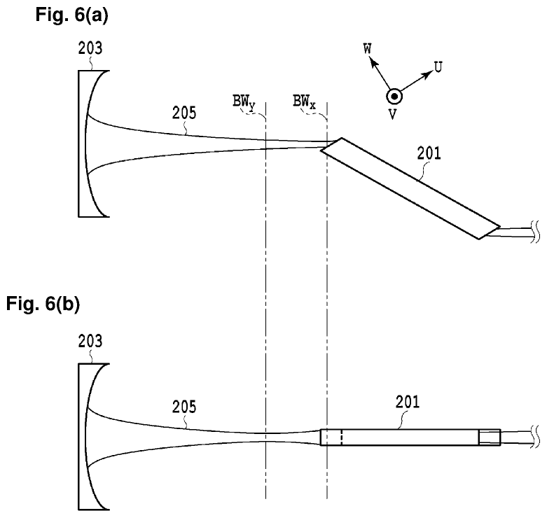

FIG. 6 illustrates propagation of an oscillated light beam that is reflected by a concave spherical mirror of a laser resonator with a configuration in which the oscillated light beam is allowed to become incident on or emerge from a facet of a single-crystal fiber, which has equal diameters in two directions orthogonal to each other within its cross-section, at the Brewster's angle. When the laser resonator is formed using the single-crystal fiber 201 illustrated in FIG. 4, and the operator sets the direction of the normal to the facet of the single-crystal fiber 201 as the W-axis and sets the U-axis so that the optical axis of an oscillated light beam 205 and the optical axis of the waveguide of the single-crystal fiber 201 become parallel with the UW plane as illustrated in FIG. 6(a), the angle θ between the W-axis and the optical axis of the single-crystal fiber 201 is set to satisfy Formula 2. When the single-crystal fiber 201 and a concave spherical mirror 203 are arranged to allow the oscillated light beam 205 to become incident or emerge at the Brewster's angle, there will be a large difference between the beam radii in the two directions as indicated by Formula 3 if the diameters Dx and Dy in the two directions of the cross-section of the single-crystal fiber 201 are equal. Consequently, as illustrated in FIGS. 6(a) and 6(b), a non-negligible difference occurs between the position BWx of the beam waist in the X-direction and the position BWy of the beam waist in the Y-direction of the oscillated light beam 205.

As an example, the coupling efficiency η when the single-crystal fiber 201 having equal Dx and Dy (Dx=Dy=120 μm) as described above and the concave spherical mirror 203 with a radius of curvature of 15 mm are used is calculated. The beam radii are found to be ωₓ₂=ω_{y}=30 μm and ωₓ₁=16.5 μm. Provided that the oscillation wavelength is λ=1.5 μm, the difference L (BWx−BWy) between the position of the beam waist in the X-direction and that in the Y-direction is calculated as 435 μm from the formula of a Gaussian beam. When the fundamental mode in the waveguide of the single-crystal fiber 201 is approximated using a Gaussian beam, the coupling efficiency η is expressed by the following formula (see Non-Patent Literature 3).

$$Formula 1$$

$$η = \frac{2}{\sqrt{4 + \frac{{λ}^{2} {L}^{2}}{{π}^{2} {ω}_{y}^{4}}}} \qquad ( Formula 4 )$$

From this formula, the coupling efficiency is calculated as η=0.993. This is a non-negligible value considering that the output coupling is 0.01.

When the efficiency of optical coupling between the fundamental transverse mode in the single-crystal fiber and an oscillated light beam propagating in the space of the laser resonator decreases as described above, the round-trip loss of the laser resonator will increase. This in turn will increase the oscillation threshold and decrease the laser oscillation efficiency. Herein, it is possible to add a new optical element to the space optics of the laser resonator so as to allow the position of a beam waist in the X-direction of a folded light beam to coincide with that in the Y-direction. However, adding an optical element involves a new optical loss. Thus, sufficient advantageous effects of the laser oscillator cannot be obtained.

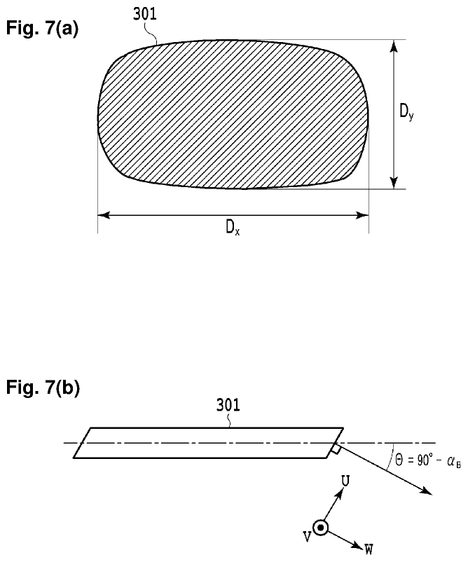

FIG. 7 illustrates the structure of a single-crystal fiber of the present embodiment. The diameters Dx and Dy in two directions of a cross-section of a single-crystal fiber 301 have a relationship represented by the following formula (FIG. 7(a)). The diameters Dx and Dy are the diameters in the X-direction and the Y-direction, respectively, as defined in the description made with reference to FIG. 5.

Dx=(n₂/n₁)Dy (Formula 5)

To obtain favorable oscillation efficiency, the polarization direction of each of an excitation light beam and an oscillated light beam should be set to coincide with the crystal orientation that exhibits the maximum amplification for an incident linearly polarized light beam (for example, see Non-Patent Literature 1). Regarding Cr⁴⁺:YAG crystals, the crystal orientation that exhibits the maximum amplification is the crystal axis orientation. Thus, the X-axis is set to coincide with the crystal axis orientation. Regarding the opposite facets of the single-crystal fiber 301, the angle between the direction of the normal to each facet and the optical axis is set to 90°−α_{B}, that is, 29° so that a light beam incident on or output from the facet has the Brewster's angle α_{B} (FIG. 7(b)).

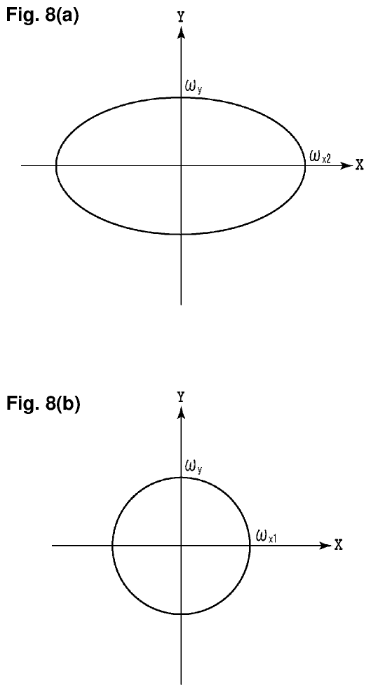

FIG. 8(a) illustrates the shape of an oscillated light beam in a cross-section of the single-crystal fiber 301 of the present embodiment. FIG. 8(b) illustrates the shape of the oscillated light beam immediately after it has emerged from the single-crystal fiber 301 at the Brewster's angle. Regarding the beam radius (ωₓ₁) with respect to the X-axis direction of the oscillated light beam propagating in the space of the resonator, the beam radius (ωₓ₂) in the single-crystal fiber is calculated as follows from Formula 5:

ωₓ₂=(n₂/n₁)ω_{y} (Formula 6).
Thus, ω_{y}=ωₓ₁ from Formula 3.

Thus, since an oscillated light beam 305 from a concave spherical mirror 303 does not have a difference between the beam waist positions BW in the X-direction and the Y-direction, the coupling efficiency η of Formula 4 is 1.

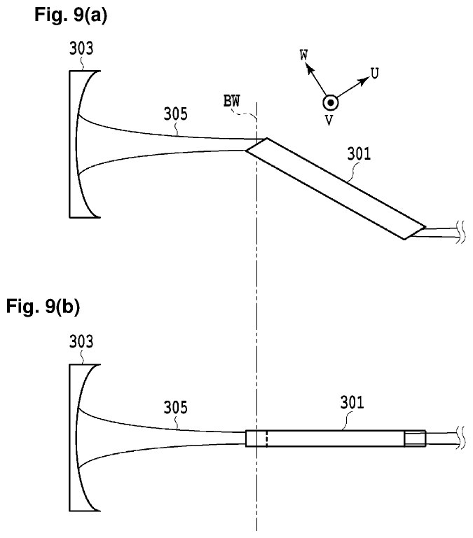

FIG. 9 illustrates a laser resonator that uses the single-crystal fiber of the present embodiment. The laser resonator includes the single-crystal fiber 301 and the concave spherical mirror 303 arranged to reflect an output light beam from one end of the single-crystal fiber 301 so as to allow it to become incident on the single-crystal fiber 301 again. As a specific example of the single-crystal fiber 301, a single-crystal fiber with Dx=218 μm and Dy=120 μm can be used. To obtain the advantageous effects of the present embodiment, the diameters in the two directions of the cross-section of the single-crystal fiber 301 should be set in the following range:

(n₂/n₁)0.9≤Dx/Dy≤(n₂/n₁)1.1 (Formula 7).

According to the present embodiment, the operator can minimize the facet reflection for each of the wavelengths of an excitation light beam and an oscillated light beam by setting the angles of incidence and emergence of the beams at the single-crystal fiber to the Brewster's angle. In addition, favorable optical coupling can be obtained between an oscillated light beam propagating in the space of the laser resonator and the fundamental transverse mode of a light beam propagating in the single-crystal fiber, which can thus improve the laser oscillation efficiency.

It is obvious that the present embodiment is effective not only for Cr⁴⁺:YAG single-crystal fibers but also for single-crystal fibers that use other laser crystals. As the laser crystals, YAG crystals doped with at least one type of an element selected from the group consisting of Yb, Nd, Er, Tm, and Ho; Ti sapphire crystals; or Cr forsterite crystals can be used.

### REFERENCE SIGNS LIST

1 Interface
2 Incoming light beam
3 Polarization direction
4 Space
5 Crystal
101, 201, 301 Single-crystal fiber
102 Anti-reflective coating
103, 203, 303 Concave spherical mirror
104 Plane mirror
105, 205, 305 Oscillated light beam
106 Excitation light beam

1. A single-crystal fiber comprising a waveguide structure for a wavelength to be subjected to optical amplification,
wherein:
at least one end of the single-crystal fiber is planar,
an angle θ between a normal to a facet of the single-crystal fiber and an optical axis of the single-crystal fiber satisfies a relationship of:
θ=90°−tan⁻¹(n₂/n₁),
where n₁ represents a refractive index of a medium of a space that uses the single-crystal fiber, and n₂ represents a refractive index of the single-crystal fiber for a guided light beam having a polarization direction parallel with a plane that includes the normal to the facet and the optical axis, and
a diameter Dx in an X-direction and a diameter Dy in a Y-direction of a cross-section of the single-crystal fiber perpendicular to the optical axis satisfies a relationship of:
(n₂/n₁)0.9≤Dx/Dy≤(n₂/n₁)1.1,
where the X-direction is a direction perpendicular to the optical axis of the single-crystal fiber and the Y-direction is a direction perpendicular to the optical axis of the single-crystal fiber and to the X-direction in a plane that includes the optical axis of the single-crystal fiber and the normal to the facet of the single-crystal fiber.

2. The single-crystal fiber according to claim 1, wherein a crystal orientation that exhibits a maximum amplification for an incident linearly polarized light beam is set to coincide with the X-direction of the single-crystal fiber.

3. The single-crystal fiber according to claim 1, comprising Y₃Al₅O₁₂ (YAG) crystals doped with tetravalent Cr atoms; YAG crystals doped with at least one type of an element selected from the group consisting of Yb, Nd, Er, Tm, and Ho; Ti sapphire crystals; or Cr forsterite crystals.

4. The single-crystal fiber according to claim 2, comprising Y₃Al₅O₁₂ (YAG) crystals doped with tetravalent Cr atoms; YAG crystals doped with at least one type of an element selected from the group consisting of Yb, Nd, Er, Tm, and Ho; Ti sapphire crystals; or Cr forsterite crystals.
